(19) United States
(12) Patent Application Publication
(10) Pub. No.: US 2014/0057566 A1
(43) Pub. Date: Feb. 27, 2014

(54) ENHANCED HIGHER LAYER DISCOVERY METHODS FOR PROXIMITY SERVICES

(71) Applicant: INTERDIGITAL PATENT HOLDINGS, INC., Wilimington, DE (US)

(72) Inventors: Mahmoud Watfa, Saint Leonard (CA); Kai Liu, S. Huntington, NY (US); Saad Ahmad, Montreal (CA); Ulises Olvera-Hernandez, Montreal (CA)

(21) Appl. No.: 13/971,896

(22) Filed: Aug. 21, 2013

Related U.S. Application Data
(60) Provisional application No. 61/691,542, filed on Aug. 21, 2012.

(51) Int. Cl. H04W 48/16

(52) U.S. Cl. CPC H04W 48/16
USPC 455/41.2

(57) ABSTRACT

Systems, methods, and instrumentalities are disclosed to a method of establishing a wireless connection. The wireless connection may be an interface between an eNodeB and a proximity server. The interface may a direct interface between the eNodeB and the proximity server, for example, such that the only node between a wireless transmit/receive unit (WTRU) and the proximity server on the interface is the eNodeB. The interface may be a user plane interface. An eNodeB may receive an indication to set up the interface between the eNodeB and the proximity server. The indication may be a S1AP message received from a mobility management entity (MME), an RRC message received from the WTRU, and/or the eNodeB discovering the proximity server. Upon receiving the indication, the eNodeB may establish the interface between the eNodeB and the proximity server. The eNodeB and/or the proximity server may utilize unique session identification to identify the WTRU.

### CROSS-REFERENCE TO RELATED APPLICATION

This application claims the benefit of U.S. Provisional Patent Application No. 61/691,542, filed Aug. 21, 2012.

### BACKGROUND

3GPP proximity-based service may be enabled for commercial/social use, network offloading, public safety, and integration of current infrastructure services to assure the consistency of the user experience including reachability and mobility aspects. 3GPP proximity-based service may be enabled for public safety, for example, in the absence of EUTRAN coverage. This may be subject to regional regulation and/or operator policy, and limited to specific public-safety designated frequency bands and terminals.

Proximity-based services may comprise proximity discovery of a wireless transmit/receive unit (WTRU), a WTRU's consent to being discoverable, contactable or conversational, proximity WTRU to WTRU communications, the controllability and policies by the network and/or operators to the discovery, discoverability, and/or other forms of communication.

### SUMMARY

Systems, methods, and instrumentalities are disclosed for establishing a wireless connection. The wireless connection may be an interface between an eNodeB and a proximity server. The interface may a direct interface between the eNodeB and the proximity server, for example, such that the only node between a wireless transmit/receive unit (WTRU) and the proximity server on the interface is the eNodeB. The interface may be a control plane interface.

A method of establishing the interface may comprise receiving, with the eNodeB, an indication to set up the interface between the eNodeB and the proximity server. The indication may be a S1AP message received from a mobility management entity (MME). The indication may be an RRC message received from the WTRU. The indication may be the eNodeB discovering the proximity server.

Upon receiving the indication, the eNodeB may establish the interface between the eNodeB and the proximity server. The proximity server may transmit a data stream to the WTRU over the interface. The WTRU may receive the data stream over the interface. The eNodeB and/or the proximity server may utilize a unique session identification to identify the WTRU. Subscription information of the WTRU may be used to indicate whether or not the WTRU may communicate with the proximity server over the interface.

The WTRU may transmit, to the proximity server, a request to establish for one or more proximity services over the interface with the proximity server. The proximity server may establish one or more proximity services for one or more applications and/or one or more users within an application with the WTRU over the interface.

Prior to the establishment of the interface between the eNodeB and the proximity server, the WTRU may transmit an address and/or a name of the proximity server to the MME. The MME may receive the address and/or the name of the proximity server and may transmit an indication to the eNodeB to set up the interface between the eNodeB and the proximity server for the WTRU.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIGS. 2-4 are diagrams illustrating examples of WTRU communication.

FIG. 5 is a diagram illustrating an example of an interface that connects a RAN directly to a proximity server.

FIG. 6 is a flow diagram illustrating an example of a proximity server requesting the HSS to set a notification request at the MME for proximity.

FIG. 7 is a flow diagram illustrating an example signal flow.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

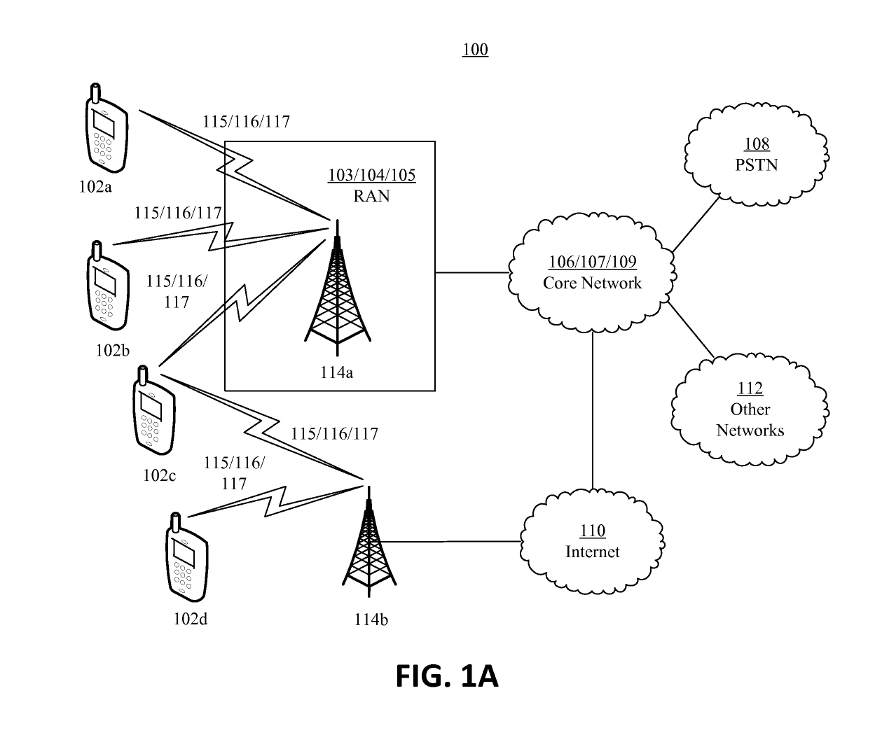

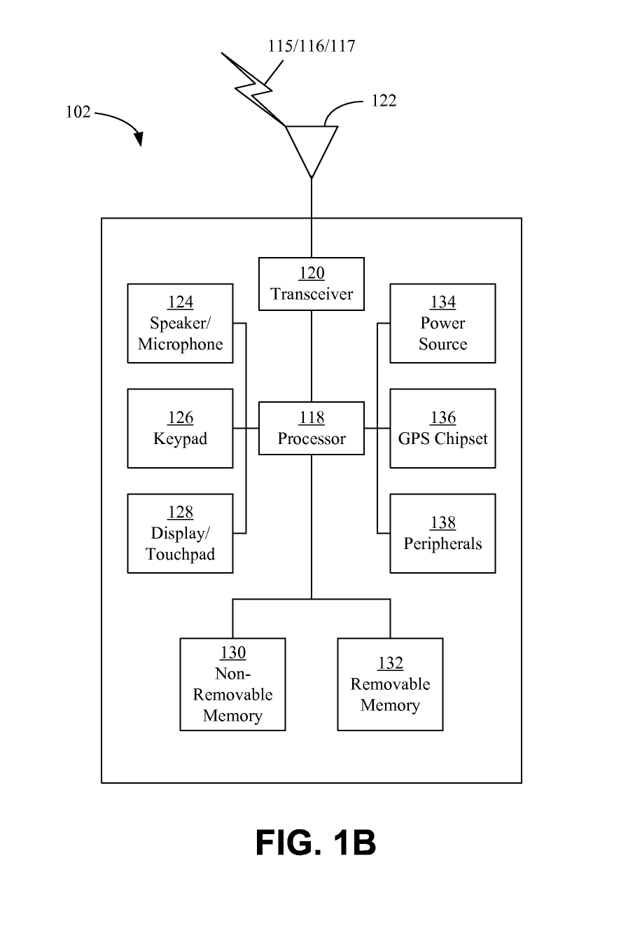

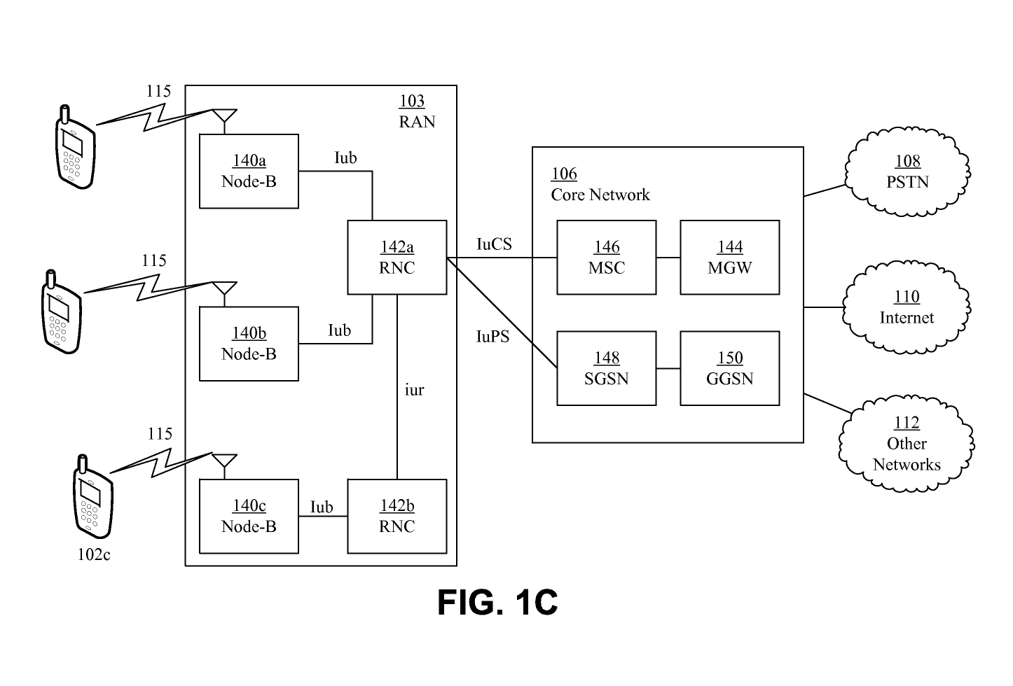

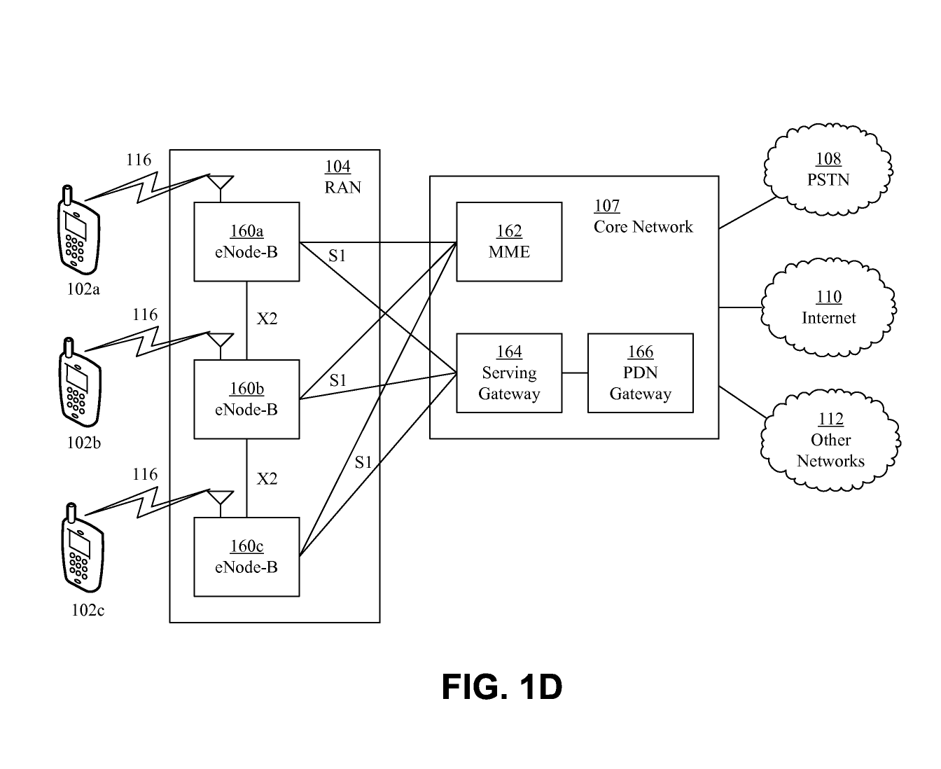

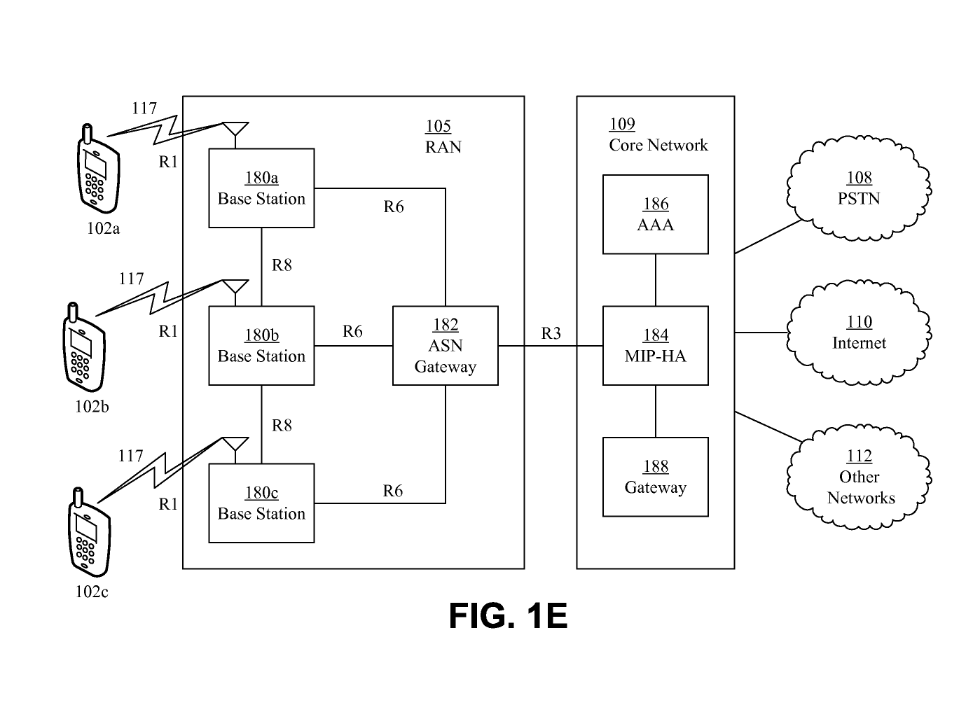

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination implementation while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Proximity may refer to direct communication and/or local communication, e.g., direct communication via an eNodeB. Proximity may not be limited to a specific range of distance.

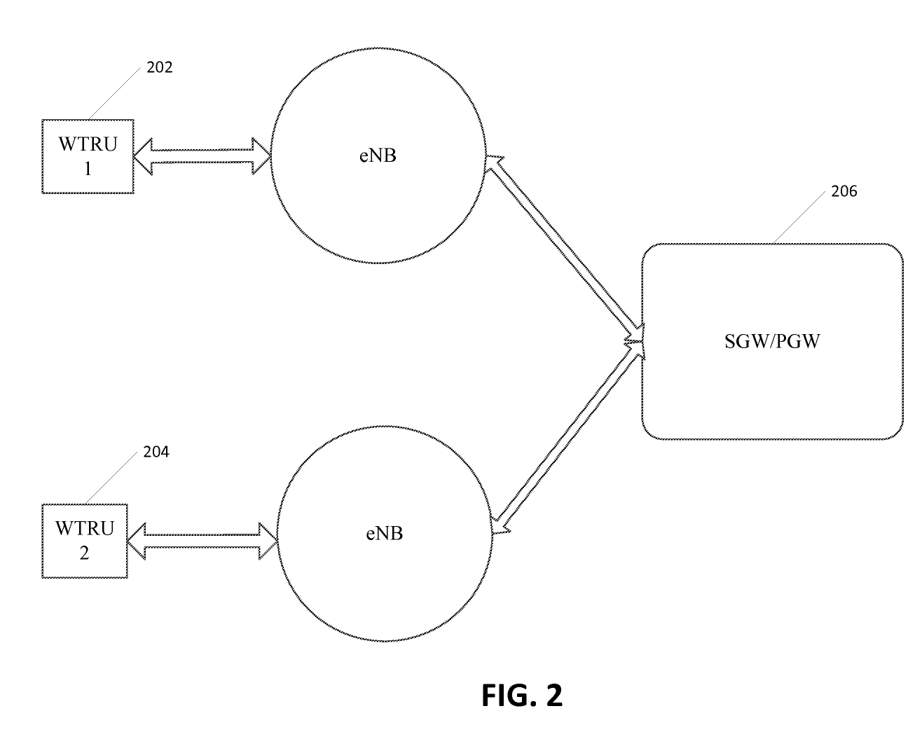

FIG. 2 is a diagram illustrating an example of WTRU communication. If WTRUs 202 and 204 are close to each other, then communication between the WTRUs 202 and 204 may travel via CN nodes, for example a SGW and/or a PDN GW 206.

With the introduction of the Proximity Study Item (SI), the communications between proximity WTRUs may be enhanced to take other paths such as, but not limited to, direct (e.g., direct radio path in licensed/unlicensed spectrum) and/or indirect (e.g., through network elements, and/or intra/inter-cell and/or intra/inter-eNodeB and/or S-GW, etc.), which may be controlled by the network and/or by operators.

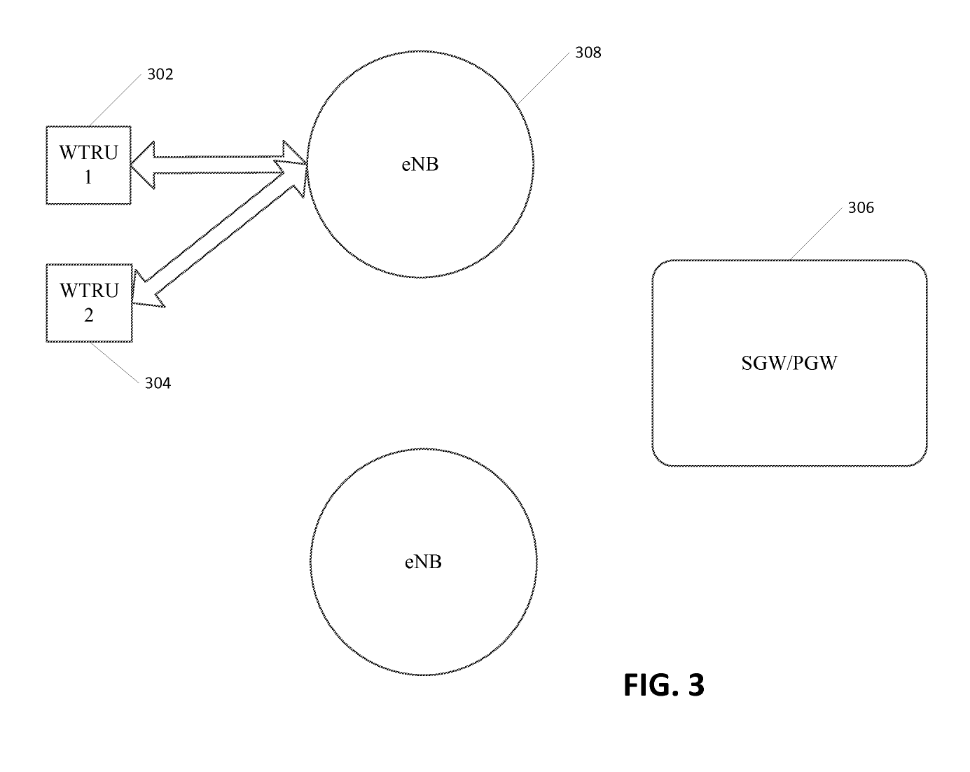

FIG. 3 is a diagram illustrating an example of WTRU communication between two WTRUs 302 and 304. For example, data sharing may be under proximity, model-1, where a common network node 306 may be closed. A data path for Proximity Communications (e.g., locally routed via an eNodeB 308) may be described herein.

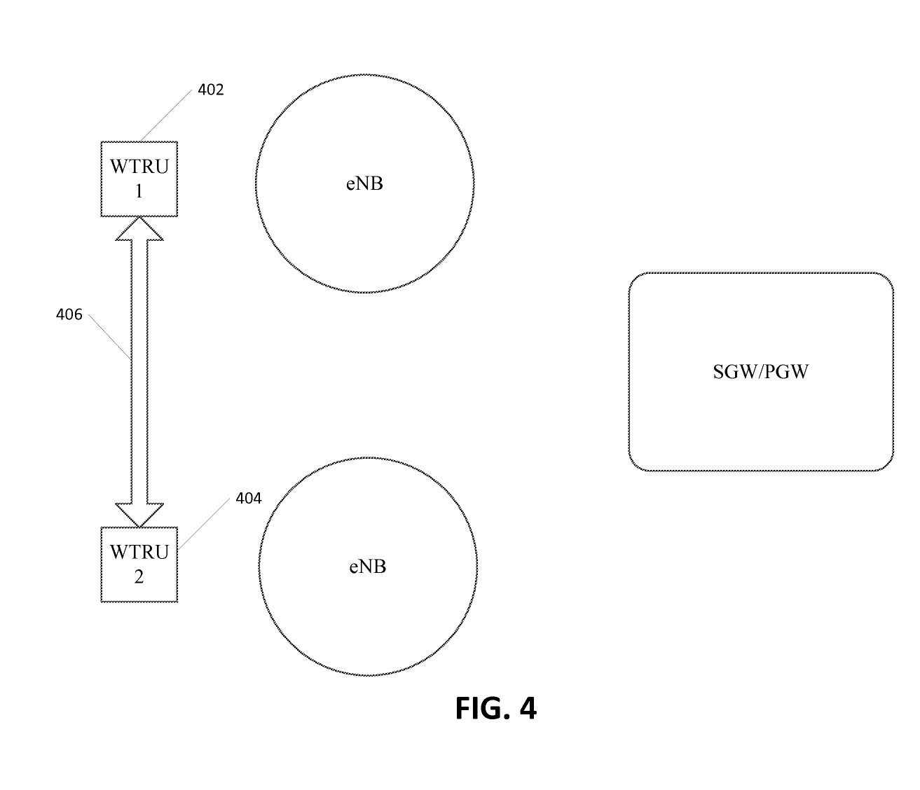

FIG. 4 is a diagram illustrating an example of WTRU communication between two WTRUs 402 and 404. For example, data sharing may be under proximity, model-2, where the WTRUs may communicate via a direct path 406. The data path 406 may connect the WTRU 402 to the WTRU 404 directly over an air interface.

The proximity service data path selection (e.g., direct or indirect over a certain path in the infrastructure) may be determined by the radio coverage, network coverage, load conditions, and/or by policies set by network or operators. Proximity-Based Services may be supported in network sharing deployments.

To enable proximity services (e.g., direct communication over the radio and/or via another path), the devices may discover each other. Discovery may be done over the LTE network and may be controlled by the network. Implementations to discover WTRUs via the operator network using Non-Access Stratum (NAS) and/or Radio Resource Control (RRC) procedures may be described herein.

NAS-based implementations may be used for discovery. Radio level implementations may be used for discovery. The type of information that may be included in NAS messages, which may be used for discovery purposes, may be described herein.

Sending NAS messages for proximity to the MME may put processing burden on the mobility management entity (MME). Even though the MME may be involved in controlling the proximity session, having the MME be involved for discovery purposes may increase the signaling at the MME, for example, if such messages are to be sent for multiple applications, and may affect multiple WTRUs.

When a WTRU is in idle mode, the WTRU may go back to connected mode due to a request from the NAS (e.g., a Service Request or Tracking Area Update). The WTRU may go back to connected mode due to a paging reception, which may trigger the NAS Service Request procedure. The WTRU may not be in a RRC connected state while the NAS is idle (e.g., there may not be a NAS signaling connection between the WTRU and the MME, where a NAS signaling connection may be established upon the transmission of a NAS message by the WTRU and its reception by the MME). If a proximity server is connected to the RAN, certain applications may communicate with the proximity server during times when the WTRU is in idle mode. Since the communication may occur in a connected mode and one way to go to a connected mode (e.g., for mobile originated cases) may be due to a request from the NAS, a NAS message may be sent to bring the WTRU into a connected mode. The NAS procedure (e.g., a Service Request procedure) may involve signaling at the MME and may lead to the setting up of user plane resources as per LTE operation. Even though the WTRU may not want to communicate with the MME (e.g., the WTRU may communicate with the server and may, for example, forego communicating with the MME), by sending a NAS message, the MME may be involved unnecessarily. Potentially unused user plane resources may be set up. Implementations to enable a WTRU to go to a connected mode without involving the MME (e.g., without the WTRU having to establish a NAS signaling connection with the MME) may be described herein.

NAS and RRC implementations that may perform WTRU discovery and/or provide discovery information for proximity services may be described herein.

A proximity server may be present in the network. An interface and architecture for a proximity server may be described herein. A proximity server may be in a network and may be connected to the MME. A proximity server may be connected (e.g., directly connected) to a RAN.

While a WTRU may use IP, e.g., user plane bearers, to communicate with a proximity server, implementations other than IP may be used by a WTRU to communicate with a server.

NAS messages may be used to communicate discovery. Content, which may be used for discovery, may be included in NAS messages.

A direct connection between the RAN and the proximity server may allow the MME to be offloaded from handling proximity-related messages. The MME may be removed from the communication path of the WTRU and the proximity server.

At least one application may request service from the proximity server. There may be multiple updates per application per WTRU. For example, some applications, such as Facebook®, may perform multiple status updates per minute. If a proximity server is in a network and connected to the MME, the MME may handle (e.g., perform interworking and forwarding proximity messages between the WTRU and the server) thousands of messages in a very short time. This may increase the load on MME handling and may cause the system to be congested. Congestion of the MME may cause WTRUs to become incapable of accessing the system for basic services (e.g., voice).

The offloading of the MME from handling proximity-related messages may be inline with efforts to offload the core network from data. For example, Selected IP Traffic Offload (SIPTO) may offload the core network from the user plane so that congestion may be avoided. A local packet data gateway may be selected, based on the user's location, to offload the core network's PDN GW.

A RAN-proximity server connection may bring the proximity server closer to the RAN, which may be the first point of access for the WTRU. The communication with the proximity server may be faster because there may be fewer nodes in between the WTRU and the server.

With an MME-to-proximity server connection, the nodes between the WTRU and the proximity server may include the eNodeB and the MME. The MME may have to do processing to forward the message between the WTRU and the proximity server.

With a direct eNodeB-proximity server connection, the eNodeB may be a node (e.g., the only node) between the WTRU and the proximity server. Even though the eNodeB may perform some interworking to forward messages between the WTRU and the server, there may be one less node in the path. This may make the communication between the WTRU and the proximity server faster.

The MME may receive a higher priority NAS request from the same WTRU that sends a proximity message. The MME may not process the proximity message towards the server due to the higher priority NAS message. If a direct eNodeB-server connection is used, this may not occur at the MME and proximity messages may be processed (e.g., forwarded to the server by the eNodeB).

A proximity request or message may refer to a request for proximity services, such as, but not limited to, discovery messages.

A proximity or status update may refer to a modification to the discovery status of a user. This may be for at least one application. For example, the modification may be that the user wants to be discoverable or does not want to be discoverable, wants to request the discovery of other users, and/or wants to set a condition/event that might cause the recipient to take an action when the condition/event is met (e.g., a user may request to be informed when at least one other user is in an area, which may be for at least one application).

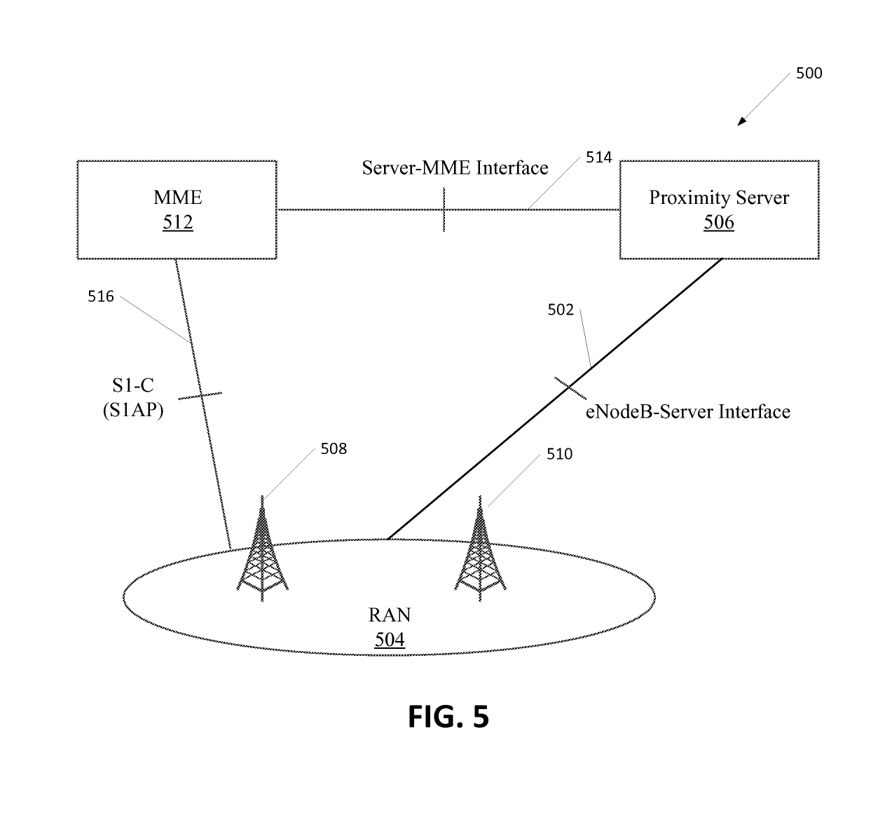

Interfaces, such as that shown in FIG. 5, which may provide a direct connection between a proximity server and a RAN, may be described herein. FIG. 5 is a diagram illustrating an example system 500 having an interface 502 that may connect a RAN 504 to a proximity server 506, e.g., may connect the RAN 504 directly to the proximity server 506. The proximity server 506 may be co-located with the eNodeB or may be a standalone server connected to multiple eNodeBs 508, 510, for example, as shown in FIG. 5. The proximity server 506 may also communicate with a MME 512 via an interface 514. The MME 512 may communicate with the RAN 504 via an interface, such as an S1-C interface 516 using S1-AP messaging.

A WTRU may send discovery and/or other proximity related messages using, for example, RRC messages, which may be forwarded to the proximity server 506. For example, the proximity messages may be piggybacked in an RRC message and sent to the eNodeB. Upon reception, the eNodeB may remove the proximity message and send the proximity message to the appropriate proximity server using an interface described herein, e.g., the interface 502 of FIG. 5. A WTRU may have communication with multiple servers. The eNodeB may have multiple connections (e.g., simultaneous and independent connections) to multiple servers.

The WTRU may indicate its support for use of an RRC message to communicate discovery or other proximity-related messages when it registers to the system (e.g., in a NAS Attach Request message). The MME 512 may inform the eNodeB to support for use of an RRC message in this way (e.g., use this interface to forward messages between the WTRU and the proximity server 506) for a particular WTRU, e.g., upon context setup.

The WTRU may send proximity messages over RRC messages and/or using modified RRC messages. The proximity messages may comprise a NAS message that may be forwarded by the RAN 504 to the proximity server 506, which may have minimal NAS capability, e.g., the ability to read NAS messages. The term “RRC message” may refer to an RRC message or may refer to an RRC message that encapsulates a NAS message. The term “proximity message” may refer to a NAS message that may be used for proximity or an “RRC message” as defined herein. The proximity message may be sent by the WTRU to the MME 512 or to the proximity server 506 via an interface described herein, e.g., the interface 502.

The RAN 504 may broadcast the support of the interface 502 in the system information message or system information blocks. A WTRU may use this broadcast to start the sending of proximity messages to the proximity server 506 via an RRC message. A WTRU may use the broadcast information to request the MME 512 to setup a connection with the proximity server 506. Once a connection with the proximity server 506 is established with the help of the MME 512, the WTRU may start sending proximity messages to the proximity server 506 via an RRC message.

The MME 512 may indicate the support of the interface 502 to the WTRUs via one or more NAS messages.

The interfaces described herein may comprise a user plane interface. The user plane for Device-to-Device (D2D) communication may go through the proximity server 506 when the data does not go through the direct path. For example, the proximity server 506 may act as a user plane anchor when two WTRUs performing D2D communication may be under the coverage of different eNodeBs or under different MMEs, PLMNs, etc. The user plane traffic may be sent from one proximity server to another and then to the target WTRU(s). The proximity servers may be connected to each other as well.

The interfaces described herein may be realized with any transport protocol such as, but not limited to IP, GTP, etc.

Subscription-based activation of direct RAN-Proximity Server interfaces may be described herein. The determination of whether or not an eNodeB may communicate directly to a proximity server may be controlled by subscription at the HSS or another subscriber repository. A WTRU subscription may indicate the eNodeB or eNodeBs that is or are allowed to communicate to a proximity server. For example, the subscription information may be indicated on a per Tracking Area basis or individually on a per eNodeB basis. The subscription information may include the proximity server address(es) and/or proximity server name(s) that may be contacted for the WTRU in question.

When the WTRU attaches to the network, and upon a location update procedure, the HSS may communicate to the MME the one or more eNodeBs that may be allowed to communicate to the proximity server(s). The HSS may also communicate to the MME which eNodeBs communicate with which servers. The HSS may provide the list of servers that are allowed and/or that may be used for the WTRU.

The MME may inform the relevant eNodeB(s) whether a direct connection to at least one proximity server may be warranted. The MME may include the address of the relevant server(s) and/or any other information that may allow an eNodeB to contact the server(s), e.g., a Fully Qualified Domain Name (FQDM). Implementations relating to how the MME may inform relevant eNodeBs regarding proximity behavior may be described herein.

A proximity server and/or another entity requiring proximity services may request the activation of proximity services using a WTRU Reachability Procedure. For example, when a proximity server requests a WTRU reachability status, the proximity server may request proximity services. The HSS may use a modified version of a WTRU-REACHABILITY NOTIFICATION REQUEST message to add the proximity information that may allow the HSS to request proximity services on behalf of the proximity entity and/or proximity server.

On receipt of the WTRU-REACHABILITY NOTIFICATION REQUEST message, e.g., a modified REACHABILITY NOTIFICATION REQUEST, the MME may activate proximity services and may execute reachability procedures.

If the WTRU was idle when the WTRU-REACHABILITY NOTIFICATION REQUEST message was received in the MME, the MME may set the URRP-MME flag to indicate that such request has been received. For example, this may be established by the current behavior. The URRP-MME flag may be modified and/or another flag may be used to indicate that the MME and/or the eNodeB may provide a proximity notification to the proximity server upon detection of NAS or RRC activity.

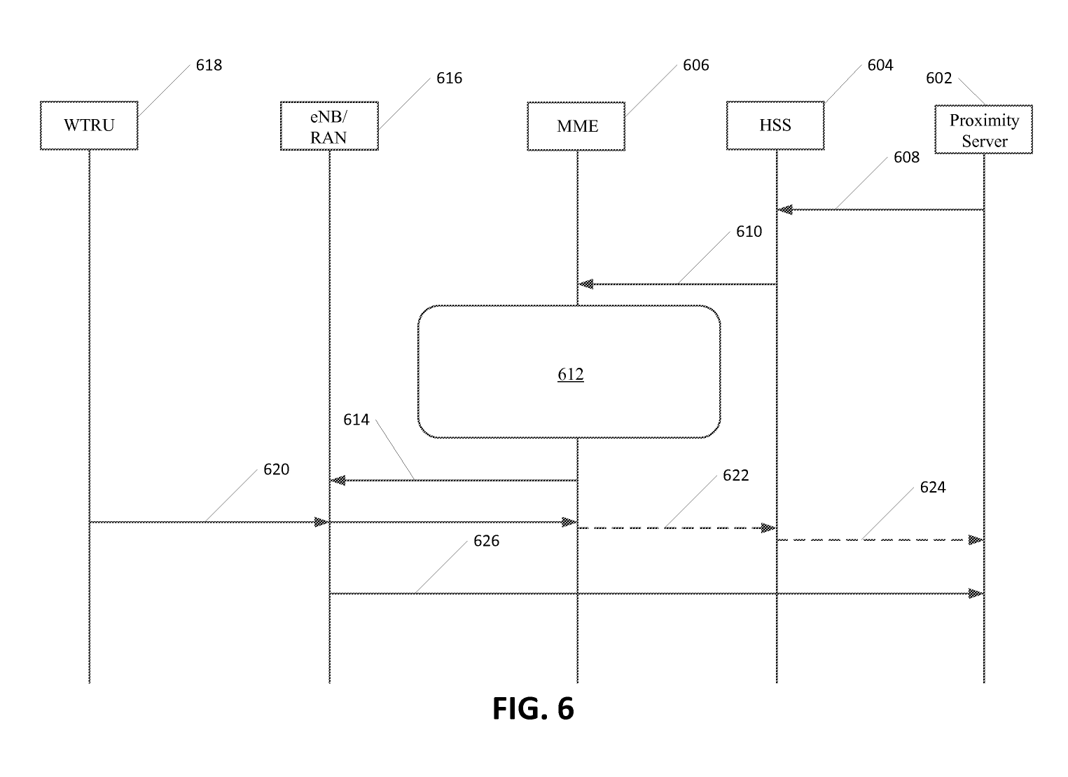

FIG. 6 depicts an example of how a notification request may be set at the MME for proximity. FIG. 6 is a flow diagram illustrating an example of a proximity server 602 requesting a home subscriber server (HSS) 604 to set a notification request at a mobility management entity (MME) 606 for proximity.

At 608, the proximity server 602 may send a request to the HSS 604 to receive a notification about a WTRU presence/location/attachment to the system and may provide the identity of at least one WTRU. The proximity server 602 may request proximity services from the HSS 604, for example, over an Sh interface. At 610, the HSS 604 may send the request to at least one MME 606. For example, the HSS 604 may send a WTRU-REACHABILITY-NOTIFICATION REQUEST message to trigger proximity services.

The at least one MME 606 may save an indication/flag to notify the proximity server 602 when at least one WTRU attaches to the system and/or comes to connected mode. At 612, the at least one MME 606 may notify eNodeBs belonging to a particular tracking area identity (TAI) that proximity services may be enabled. The at least one MME 606 may communicate proximity events to the HSS 604 upon receipt of a tracking area update (TAU) or ATTACH event.

The HSS 604 may provide the MME 606 with the proximity server address/name that may be contacted for each WTRU. At 614, the MME 606 may activate a proximity flag. The MME 606 may send the request from the HSS 604 to at least one eNodeB 616 and may include at least one WTRU 618 and the address/name of at least one server. When the WTRU 618 comes to connected mode (e.g., during an attach, tracking area update, or service request, or for any other NAS procedure), the eNodeB and/or the MME may inform the proximity server 602 about the WTRU's detected presence. For example, at 620, the WTRU 618 may inform the MME 606 about an ATTACH or tracking area update (TAU) event. The MME 606 may inform the HSS 604 about the WTRU's presence. For example, at 622, the MME 606 may notify the HSS 604 about this event. The HSS 604 may notify the proximity server 602 about the event at 624. The eNodeB 616 may send a PROXIMITY notification to the proximity server 602 at 626.

A WTRU may indicate one or more of the following in a NAS message, e.g., an Attach Request or Tracking Area Update (TAU) message or a NAS message. A WTRU may indicate a count of applications that use or need proximity services. A WTRU may indicate the application identities that may be active and/or call for proximity service. These application identities may be indicated using a bitmap in which a bit position may be reserved for an application, and a value of 0 may indicate that the WTRU may not want to be discovered for the application, while a value of 1 may indicate that the WTRU may want to be discoverable for the application. More bits may also be defined to define other actions. A WTRU may indicate whether or not the WTRU wants to enable or disable proximity service. Proximity service may be enabled or disabled on a per application basis. A WTRU may indicate a request to setup a connection with a proximity server. Such a request may be identified by a known address or name.

The WTRU may send such information when it performs a Tracking Area Update. This may be sent when the information in the WTRU has changed. For example, if the WTRU's applications that call for proximity have changed or if the discovery status of the WTRU has changed per application when the WTRU was in idle mode, then the WTRU may include such information in the TAU message to indicate changes in the WTRU. The MME may signal information to the proximity server to modify the WTRU's discovery status for the application in question, which may be in use by the WTRU under consideration. The proximity server may take implementations to update other WTRUs about the change of the status of the WTRU in question. These implementations may be described in more detail herein.

The WTRU may send this information in other NAS messages, such as a modified NAS message, when the WTRU may be in connected mode (e.g., when the WTRU has a NAS connection with the core network). The WTRU may send such information to the proximity server directly as disclosed herein, e.g., using an interface described herein, such as the interface 502 of FIG. 5. The WTRU may send (e.g., may only send) a status update (e.g., where a status update may imply a change in the WTRU's preference to be discovered, or a change in the WTRU's preference to discover other WTRUs, or to set triggers for proximity service) when there may be a change in the WTRU's last status, e.g., due to user intervention. The WTRU may send (e.g., may only send) a message to the proximity server to indicate its cell location without sending a status update. This may occur if the WTRU's status for proximity (or applications that call for proximity) did not change.

The WTRU may send a proximity request to the MME to disable or enable proximity service. This may be done on a per application basis or for all applications. The MME may forward this notification or request to the server, which may stop contacting the WTRU for proximity service.

Upon the occurrence of an event, the WTRU may send a proximity/RRC message, which may be forwarded to the proximity server. An event may be, but is not limited to, any of a number of occurrences.

An event may be when a WTRU is configured to send proximity/RRC messages for proximity service, e.g., discovery messages. An event may be when a WTRU receives an indication (e.g., NAS, RRC messages, or via Access Network Discovery and Selection Function (ANDSF), Open Mobile Alliance Device Management (OMA DM), Over the Air (OTA), Short Messaging Service (SMS), etc.) to use RRC messages to send proximity requests, e.g., discovery messages. An event may be when a WTRU receives indication of the support of an interface, e.g., the interface 502 between the RAN 504 and the proximity server 506 of FIG. 5. This indication may be in NAS and/or RRC (e.g., dedicated or broadcast) messages, or ANDSF, OMA DM, OTA, SMS, etc. An event may be when a user modifies a proximity status. The proximity status may be modified for at least one application.

An event may be when the WTRU goes to connected mode, even if it is not for the purpose of proximity service. A WTRU may send a proximity message to indicate its location and ability to engage. A WTRU may send a proximity message to indicate or implicitly indicate that the user has not requested blocking or terminating of the service. A WTRU may include the cell ID in its message to the proximity server. The proximity server may be able to get this information from the eNodeB that forwards the message. A WTRU may include other information such as, but not limited to CSG ID, or local network ID, which may be shared by more than one eNodeB or HeNodeB.

An event may be when the user may modify the proximity status. The proximity status may be modified for one application. The proximity status may be modified via the user interface. An event may be when the WTRU's settings change such that proximity service is enabled or disabled by the user. Proximity service may be enabled or disabled for at least one application. Disabling a proximity service may not be the same as choosing not to be discoverable. Disabling a proximity service may mean the WTRU/user is not interested in getting any updates even if the WTRU is not discoverable. An event may be when the WTRU receives a setting change to enable or disable proximity service, e.g., via ANDSF, OMA DM, OTA, SMS, or other application based communication, e.g., over the user plane. An event may be after a handover to a new cell. An event may be upon or before powering off or detaching from the system. An event may be when a change in system information related to proximity occurs.

The WTRU may be configured to use RRC messages, e.g., as per an interface, such as the interface 502 of FIG. 5, for sending proximity related information, e.g., discovery requests. The WTRU may be preconfigured to use RRC messages, for example, via OMA DM, OTA, ANDSF, etc. The WTRU may be informed by the network (e.g., RAN via RRC messages, which may be broadcast or dedicated, or by the MME in any NAS message) to use an RRC message to send proximity related information to the proximity server or to use NAS messages, which may be forwarded by an eNodeB to the proximity server.

The WTRU may be configured by the operator using, for example, OMA DM, OTA, ANDSF, or in the USIM, and/or by the proximity application running on the WTRU to select a specific proximity server. The WTRU may forward the address or some other identity of the proximity server to the MME via a NAS message or directly to the eNodeB via an RRC message so that the eNodeB may establish the interface with the proximity service. If the WTRU sends the address or indication to the MME, the MME may forward it to the eNodeB via an S1-AP message, for example as described herein.

While discovery messages may be used herein as an example, the implementations described herein are not limited to discovery messages. For example, the implementations described herein may apply to other messages that may be sent for proximity.

The WTRU may be configured by the MME or eNodeB (e.g., via ANDSF, OMA DM, OTA, SMS, etc.) to send discovery messages for an event that triggers the sending of discovery messages. For example, the user may change his/her discoverable feature, e.g., on a per application basis. This event may trigger the WTRU to send a discovery message to the network to indicate the status that is desired by the user, e.g., for a specific application.

The WTRU may be configured to send a maximum of N proximity messages, where N is an integer that may be preconfigured in the WTRU or configured by the network, in a configurable time period, which may be known at the WTRU and/or indicated by the network, e.g., using RRC and/or NAS messages, or the like.

When a threshold number of proximity messages have been sent within the allowed time (e.g., within a defined allowable time for proximity message communication), the WTRU may display a message to the user to indicate that the sending of a discovery message may not be allowed. The WTRU may buffer requests from the applications and send them when the transmission for proximity may be allowed.

The WTRU may start resending when it receives an explicit indication (e.g., NAS, RRC, or application related, or ANDSF, etc.) to do so. The WTRU may start resending when the next allowed time period for proximity communication starts or when a timer expires. For example, a timer may be started at the WTRU after the maximum number of discovery message transmissions is met.

The WTRU may be allowed to send proximity messages at known time instants, e.g., for a set of applications.

The WTRU may be informed that discovery messages may be sent for a specific set of applications. For example, the set of applications for which discovery messages may be allowed may be provided to the WTRU in NAS/RRC messages, using ANDSF, and/or OMA DM, or OTA.

A WTRU may send discovery messages to indicate the WTRU's discoverability (e.g., whether the WTRU is discoverable or not, for one or more WTRUs, and/or on a per application basis) and/or to indicate the WTRU's desire to get proximity information (e.g., updates about peer WTRU locations) related to one or more WTRUs or a subset of WTRUs. This may be done on a per application basis. Depending on the type of proximity application (e.g., social and/or public safety), the network may decide to obtain information for at least one WTRU immediately (e.g., for public safety applications in which peer WTRUs may communicate for an urgent matter). The network (e.g., MME or proximity server) may send proximity-related information to the requesting WTRU when a peer WTRU comes to connected mode. For example, this may be an event-based proximity information provisioning.

In the NAS messages that are sent for proximity (or in the messages that are sent to the proximity server using an interface, such as the interface 502 of FIG. 5), the WTRU may include the information for one or more of the implementations described herein. One message may be sent per application. One message may comprise discovery information for multiple applications and peer WTRUs. A discovery message may comprise discovery requests for one or more applications.

A discovery request may comprise an indication about the WTRU's desire to be discoverable or not. The WTRU may include a list of WTRUs for which the request may be applicable, e.g., a list of WTRUs may indicate the WTRUs that are allowed and/or not allowed to discover the WTRU in question. The requesting WTRU may include the identities of the WTRUs/users for which the request may be taken into account. These identities may be obtained locally from the application.

The WTRU may indicate that it desires to get proximity information (e.g., location information) for one or more of the WTRUs (e.g., a list of WTRUs) whose identities may be included in the message. This request may indicate that the information may be sent immediately by the proximity server or that the information may be sent when available, e.g., as per one or more of the implementations described herein. For example, the WTRU may set certain triggers in the message. A trigger may be that the WTRU obtains proximity information when a peer WTRU/user enters a known area, e.g., a store or a mall. The user may input the area using the device's interface. A trigger may be that the WTRU obtains proximity information when a peer WTRU uses an application. A trigger may be that the WTRU obtains proximity information when a peer WTRU is under the same eNodeB or under a neighboring eNodeB. The neighboring eNodeB may have an X2 interface with the user's serving eNodeB. A trigger may be that the WTRU obtains proximity information when a peer WTRU goes to connected mode. A trigger may be that the WTRU obtains proximity information when a peer WTRU is in a particular local network, under a particular CSG coverage, etc. A trigger may be that the WTRU obtains proximity information when a WTRU or user comes in the proximity with whom the WTRU has communicated before. The WTRU may set other triggers than the triggers disclosed herein.

The WTRU may indicate that it desires to disable or enable proximity service. Proximity service may be disabled or enabled for one or more applications. The WTRU may indicate (e.g., may be implicit when requesting disabling of the service) that it does not want to get any status updates for one or more applications. This indication may be for one or more WTRUs. The WTRU may indicate a time during which it desires to enable or disable, not be discoverable, etc. This indication may be for one application. This indication may be for one or more WTRUs.

The WTRU may indicate its ability to engage in proximity service for public safety. The WTRU may provide useful information such as, but not limited to, public safety agent identification and/or other information that may be used. This information may comprise, for example, a group ID, which may represent the group to which the WTRU belongs.

The WTRU may set certain triggers in the message such as, but not limited to, when one or more WTRUs or users leave a proximity area. A proximity area may be a cell, a CSG, a local network, etc.

An MME may perform a number of implementations, for example, in any combination. The MME may inform an eNodeB using a S1AP message that it may perform proximity communication via an interface (e.g., use the interface 502 of FIG. 5 to forward proximity messages between the proximity server and the WTRU) for a WTRU that it may be serving. For example, this may be done using a new S1AP message or by reusing (e.g., and modifying) an existing S1AP message such as, but not limited to, the Initial Context Setup Request. The eNodeB may indicate to the WTRU (e.g., via dedicated RRC messages) that the WTRU may use a RRC message for proximity. The eNodeB may indicate the existence of this interface to the WTRU, which may lead the WTRU to use a specific message (e.g., RRC/NAS as per pre-configuration information) for communicating with the proximity server. The eNodeBs may be configured to use (e.g., always use) this interface with the proximity server. Implementations for discovery of local gateways by the RAN, e.g., for local IP access (LIPA), may be employed so that, for example, eNodeBs may discover the address of a proximity server to which they may be connected.

The MME may indicate to the proximity server that it may use an interface, e.g., the interface 502 of FIG. 5, for communication with the WTRU. This indication may be provided for individual WTRUs or for all WTRUs. The MME may provide this information when the WTRU attaches to the system. The MME may hold or obtain information (e.g., from the HSS) that indicates if the system should use the direct (e.g., proposed) interface for a WTRU in question. For example, WTRUs that are capable of providing public safety services may be allowed and/or configured to send messages to the proximity server using, for example, RRC and/or NAS messages that may be forwarded to the proximity server. The WTRUs may be allowed and/or informed to use, for example, RRC messages or other messages that may lead to the use of the direct interface between the RAN and the proximity server on a per application basis. The proximity server may be configured to use this connection for one or more WTRUs.

The MME may inform the proximity server about a WTRU's location when it goes to connected mode. This may be done for user plane. The MME may also inform the proximity server about a WTRU's location after a handover is completed, e.g., after the MME may be informed by the RAN that handover may be completed with S1 or X2 handover. The handover may be an inter-RAT handover to LTE. After an inter-RAT handover, e.g., which may trigger a tracking area update, the MME may inform the proximity server that the WTRU may be in the system. This may be done after the NAS procedure, e.g., such as Tracking Area Update or Attach Request, may be complete.

The MME may save conditions/events that may be monitored, e.g., when a WTRU comes to connected mode, enters a specific cell (e.g., CSG), enters a specific local network, and/or establishes a LIPA or other type of PDN connection, etc. The conditions may be received from the WTRU or from the proximity server. When at least one condition is met, the MME may indicate to the proximity server that the at least one condition has been met. This may be done for at least one WTRU and/or for at least one application. The MME may page a WTRU to get information about its cell level location. The MME may get this explicit request from the proximity server.

When an MME receives a proximity message (e.g., discovery messages that may be sent in NAS messages) from the WTRU, the MME may perform one or more of a number of implementations. The MME may verify the message and, if the message is intended for the proximity server, the MME may forward the message to the proximity server. The MME may perform a mapping so that an identity for the WTRU in question may be provided to the proximity server. For example, this mapping may be performed if the MME and/or the proximity server do not already have a common identity for the WTRU.

If the proximity server is not reachable and/or if other problems and/or policies in the network are present, the MME may respond to the WTRU with a NAS message to indicate that the service may not be available (e.g., may be temporarily unavailable). The MME may send the message for one or more applications, e.g., on a per application basis, for all applications, or for a set of applications. The MME may provide a backoff timer that may be applied for proximity service. The timer may be per application. If the WTRU receives a backoff timer, then the WTRU may not initiate proximity messages (e.g., discovery messages) for the one or more application (e.g., if any) while the timer is running.

The MME may inform the proximity server when a WTRU goes to connected mode if the WTRU may be allowed to use proximity services. For example, the MME may define such triggers locally as per a request from the proximity server or as per a request from a WTRU directly (e.g., a public safety WTRU may request the MME to notify the proximity server and/or other devices about when the WTRU goes or leaves connected mode). A WTRU may request the MME and/or the proximity server to be notified about the mobility state transitions of other WTRUs. This may be on a per application granularity. When a condition is met (e.g., a WTRU goes to connected mode), the MME may notify the proximity server about the mobility state of the WTRU. The MME may provide the cell ID (e.g., cell global ID, CSG cell, etc.) that is currently serving the WTRU. The MME may notify other WTRUs that are interested in knowing the mobility state of the WTRU in question. This may be done (e.g., may only be done) if the WTRUs are in connected mode. This may be done if the WTRUs are in the same cell, CSG cell, local network, etc. This may be done if any form of supported communication may be possible between the WTRUs, e.g., either direct over the air or across one or two eNodeBs.

The MME and/or the serving eNodeBs may use a handover procedure for better proximity service by moving two WTRUs/users into the proximity area. For example, this may be done to move two users under the same eNodeB or X2 linked eNodeBs by moving one WTRU from 3G to LTE service. For example, this may be done to move two users to the same CSG group by handing over one WTRU from a macro eNodeB to a CSG cell. For example, this may be done to move two users to the same CSG group by granting the non-CSG-member temporary CSG membership for proximity service and handing over one WTRU from a macro eNodeB to a CSG cell. The WTRUs may be granted membership (e.g., temporary membership) for other purposes as well, e.g., proximity service and/or other purposes.

For example, the owner of the CSG may request the network to grant membership to a WTRU whose identity (e.g., MSISDN, SIP URI, IMS identity, etc.) may be included in the request. This may be done using a NAS message or using the web for a site that may be owned by the operator. The network or operator may grant the invited WTRU a membership, e.g., temporary membership. The owner of the CSG may indicate a time period for which the visiting WTRU or user may be allowed to access the CSG. The network may charge the visiting WTRU a certain premium and/or may charge the owner of the CSG. The network may count the visiting WTRU's data volume as part of the CSG owner's utilized data volume/rate.

The MME may forward one or more proximity messages to the WTRU when received from the proximity server.

An eNodeB and/or a proximity server may perform one or more of a number of implementations, e.g., in any combination.

The eNodeB and/or the proximity server may setup a connection for a WTRU and may use a unique session ID to differentiate communication for individual WTRUs. For example, the eNodeB may setup a connection when informed by the MME to use an interface for a WTRU (e.g., an S1AP message may have such an indication, for example, as described herein). The eNodeB may provide a global cell identifier to the proximity server so that the WTRU's location may be uniquely identified at a cell level. The eNodeB may setup a signaling connection with the eNodeB (e.g., not for a specific WTRU) when it discovers that it may connect with a proximity server.

The eNodeB may setup a connection when it receives a message from a WTRU that may be forwarded to the proximity server, e.g., based on a RRC message or modifications to an existing message. For example, the eNodeB may make use of the establishment cause to decide whether to establish a session and/or a connection with the proximity server. For example, an establishment cause that indicates “mobile originated signaling” may not lead the eNodeB to establish a connection with the proximity server. An establishment cause that may be defined for proximity service and/or any other establishment cause that indicates an exchange of user plane data may lead the eNodeB to establish a connection with the proximity server.

The eNodeB and/or the proximity server may use a unique identifier that differentiates one WTRU from another. The identifier may be provided by the MME (e.g., the WTRU's S-TMSI or any other unique identifier).

The connection between the eNodeB and the proximity server may be valid (e.g., may only be valid) when the WTRU is in connected mode.

The eNodeB may release the connection with the proximity server when the eNodeB releases the WTRU's RRC connection. For example, the eNodeB may request the proximity server to remove context about a particular WTRU. The eNodeB may send a message to the proximity server to indicate that the WTRU may be in idle mode. The MME may send an indication to the proximity server to inform it that the WTRU may be in idle mode. The proximity server may release any connection it has established with the eNodeB for the WTRU based on request from applications, due to network policy, and/or a request from the MME. If the eNodeB assigned any temporary ID for the WTRU communication with the proximity server, then the eNodeB may send that ID to the MME. The same ID may be used by the proximity server and/or the eNodeB when the WTRU comes back to the connected mode.

During mobility (e.g., inter-RAT or intra-RAT, for example, with S1 or X2 handover), the source cell (e.g., which may be an eNodeB) may indicate to the target cell that a WTRU may be engaged in a proximity service. This indication may be included in the source-to-target transparent container that may be used for handover. This indication may be included in any mobility message that may be exchanged between the eNodeBs (e.g., between the source and target eNodeBs), for example, via the MME. The MME may provide this information to the target eNodeB, and/or target MME in the case of inter-MME handover, during handover and/or after the handover is complete. The source cell and/or MME may use an information element (IE) to provide such an indication. The source eNodeB or MME may indicate the address of the proximity server to the target eNodeB or MME. The source eNodeB or MME may indicate other details regarding proximity service that may be ongoing for a WTRU. For example, the source eNodeB or MME may tag certain bearers to indicate that they are being used for proximity such that they may be treated differently at the target eNodeB or MME. The source eNodeB or MME may provide a session ID and/or any other identity that may have been used by the source eNodeB or MME and/or the proximity server for distinguishing proximity context for a particular WTRU. The target eNodeB may use an indication to contact the proximity server after the handover and/or during the handover. The target eNodeB or MME may use any provided information, e.g., session identifier to uniquely identify the WTRU in the proximity server. The target eNodeB or MME may reassign a session identifier for the WTRU in question. The term session identifier may be generic and may refer to other identifiers that can uniquely distinguish a WTRU context for proximity.

The eNodeB may receive an RRC message from the WTRU that may be used for proximity, e.g., as may be transmitted over the eNodeB-to-server interface 502 of FIG. 5. The eNodeB may interwork the message to a format that may be supported by the interface 502 that connects the eNodeB and the proximity server 506. The eNodeB may forward the message from the WTRU along with other identities that enable the proximity server 506 to uniquely distinguish the WTRU in question. The eNodeB and the proximity server 506 may have already exchanged/established a unique identifier and/or session identifier for the WTRU. The eNodeB and the proximity server 506 may reassign (e.g., may always reassign) the session identifier (or any other unique identifier, such as but not limited to a proximity identifier) when the WTRU goes to connected mode. This may be for user plane.

The reception in the eNodeB of RRC messages (e.g., RRCConnectionReconfigurationComplete, ProximityIndication, ConnectionReestablishmentComplete, etc.) may trigger a proximity notification towards the proximity server 506. Although this notification may be linked to the action that triggered it, it may not be an extension of the RRC messages. It may be an independent procedure used to communicate events that may be linked to proximity.

The eNodeB may receive a request from the proximity server 506 to transmit a message to a WTRU. The proximity server 506 may include an identity that uniquely identifies the WTRU in question. The eNodeB may interwork the message and send it to the identified WTRU, for example, via RRC messages. The eNodeB may inform the proximity server 506 about problems related to the sending of a proximity message to the WTRU. The problems may include, but are not limited to, the WTRU not responding (e.g., via lower layer acknowledgments) to the sending of the message. Other problems may include, but are not limited to radio link failure and/or RRC connection reestablishment that may be in progress. The eNodeB may buffer the request and resend it to the WTRU when a connection has been reestablished. The eNodeB may indicate to the proximity server 506 that the transmission was not successful. This may be indicated with a cause code to describe the nature of the problem (e.g., an ongoing handover may be in progress). The eNodeB may inform the proximity server 506 about an ongoing handover for WTRU if the eNodeB has a connection with the proximity server 506 for the WTRU in question. This may be done even if a request is not received from the server. The eNodeB may indicate to the proximity server 506 the address of the target eNodeB where the WTRU is being handed over.

The proximity server 506 may perform one or more of a variety of implementations, e.g., in any combination. The proximity server may have some basic NAS functionalities, e.g., to process NAS messages that may be used for proximity services and/or to respond to a WTRU with NAS messages that may be used for proximity services.

The proximity server may receive a proximity service message, e.g., a discovery message, from a WTRU. The proximity service message may be received via the MME 512 and/or via the RAN 504, e.g., using the interface 502 and/or the interface 514. The message may be a NAS message (e.g., that may be sent in RRC to the eNodeB) or may be interworked by the eNodeB to a format that is supported by an interface that connects an eNodeB (or the RAN 504) with the proximity server 506, e.g., per the interface 502.

The proximity server 506 may support NAS functionalities (e.g., minimal NAS functionalities) such as, but not limited to, the processing of proximity related messages that may be sent in NAS messages. The MME 512 may forward a NAS message to the server if the message is intended for the server. The message may be the NAS message received from the WTRU or may be interworked by the MME 512 to a format that may be supported by the communication protocol that may exist between the MME 512 and the proximity server 506.

As used herein, the term “modify a WTRU status” may refer to a WTRU's request to become discoverable, to become undiscoverable, to request the discovery of one or more WTRUs, and/or to modify a trigger to discover one or more WTRUs. For example, a WTRU may set a trigger to discover another WTRU when the target WTRU enters the same cell, the same CSG cell, the same local network, etc.

One or more of a number of implementations may be performed, in any combination, by the proximity server 506 when it receives a request (e.g., via RAN or MME) for proximity service (e.g., discovery and/or a request to modify a WTRU status). The proximity server 506 may verify the request and the list of WTRUs that may be affected, e.g., the sending WTRU may want to become discoverable by one or more WTRUs. This may be for at least one application.

The proximity server 506 may verify local rules and/or policies that may be defined such that particular requests may or may not be allowed. For example, a WTRU that is using an application for public safety may not be required to change its settings such that it becomes undiscoverable by other WTRUs that use the same application. The proximity server 506 may modify the WTRU's current status to reflect the change if this is allowed. The proximity server 506 may reject the WTRU's request and respond accordingly. This may be for a particular application. The proximity server 506 may respond to the WTRU via the MME 512 or via the RAN node. The proximity server 506 may include a code for rejecting the WTRU's request. For example, for a public safety use case, the WTRU may not be allowed to become undiscoverable.

The proximity server 506 may, e.g., for each application affected, update an identified WTRU that may be affected and/or should be affected (e.g., an identified WTRU that is listed in the request) by the WTRU's request, e.g., to inform the listed WTRU about a modification of the status of the WTRU in question (e.g., discoverable, not discoverable, etc.).

The proximity server 506 may request the MME 512 to send a NAS message to one or more WTRUs that are listed in the request. This may be done (e.g., may only be done) if the WTRUs are in connected mode or are in the same cell, the same CSG cell, the same local network, etc. Such a request may be saved in the MME 512 until the affected WTRUs go to connected mode, after which the MME 512 may forward the proximity message to the WTRUs. The proximity server 506 may indicate an urgency and/or high priority request that may lead the MME 512 to page at least one WTRU for updating that WTRU with proximity related information.

The proximity server 506 may store information about the current cell that might be serving a WTRU (e.g., for one or more WTRUs that may be in connected mode, the proximity server 506 may store information about the cell ID that is serving the WTRU). The proximity server 506 may take proximity requests into account. For example, the proximity server 506 may modify a WTRU's status if the WTRUs in question may have proximity service directly over the air or via one or two eNodeBs.

The proximity server 506 may contact the WTRUs directly via the RAN (e.g., using the interface 502) and send update information, e.g., to indicate about a status modification of a WTRU. This may be done on a per application basis. The proximity server 506 may already have information about the WTRUs that are in connected mode and that may be in the same cell like the WTRU that sent the request. The proximity server 506 may generate the appropriate message and send it to the RAN. The message may indicate the WTRU for which this may be used.

The proximity server 506 may set events at the eNodeB, e.g., to get a notification when a WTRU goes to connected mode in that cell, even if a WTRU is not served in that cell. The proximity server 506 may be interested in receiving (e.g., for a specific application) a notification about one or more WTRUs that go to connected mode in a particular cell or eNodeB. This may be done if they support proximity service.

For example, a unique proximity identifier may be allocated by the MME 512 and/or may be known at the proximity server 506, the MME 512, and/or the WTRU.

The proximity server 506 may request one or more eNodeBs to notify it if one or more WTRUs goes to connected mode in that cell. The proximity server 506 may provide an identity to the eNodeB(s) that uniquely specifies a WTRU.

The eNodeB may forward a notification about a WTRU when the WTRU goes to connected mode. The WTRU may provide a proximity service identifier (e.g., for an application) when it goes to connected mode. This information may be provided to the eNodeB, for example, in RRC messages. The eNodeB may use this information as an indication to know that the WTRU has proximity services. This information may also be used to indicate that the WTRU may have a session with the proximity server 506. The eNodeB may obtain an indication from the MME 512 (e.g., as described herein) to indicate that a WTRU in question has proximity services that may use a communication with the proximity server 506 and/or to indicate that the eNodeB may communicate with a proximity server. The MME 512 may provide the address of the proximity server to the eNodeB.

The proximity server 506 may use a received indication from the eNodeB and/or the MME 512 to exchange discovery messages with the WTRU in question.

The proximity server 506 may take one or more of the implementations described herein towards the MME 512. The MME 512 may take one or more of the eNodeB implementations described herein towards the proximity server 506.

A proximity server may have one or more connections to one or more eNodeBs and/or MMEs, e.g., simultaneously. An eNodeB may have one or more connections (e.g., simultaneous connections) with one or more proximity servers.

A proximity server may be changed for a WTRU. Triggers may cause a change in a proximity server. The system (e.g., a MME, an eNodeB, and/or a WTRU) may change the current proximity server based on one or more of a variety of conditions or triggers, which may in any combination.

A change in the applications may require proximity service. The WTRU may be configured with information regarding the address of the appropriate proximity server to contact per application. If the WTRU's set of applications that call for proximity services change, then the WTRU may use this information to request a connection with at least one other proximity server. The WTRU may be pre-configured with this information. For example, the WTRU may already have this information saved in the USIM and/or non-volatile memory. The MME may provide this information to the WTRU via NAS messages (e.g., modified messages). The eNodeB may provide the WTRU with this information using messages (e.g., modified messages) after having received this information from the MME over S1AP signaling. The MME may provide this information to the eNodeB (for example, using S1AP messages, e.g., modified S1AP messages), which may trigger the eNodeB to send this information to the WTRU). The proximity server may propose other servers that may be used. This may be done on a per application basis.

The WTRU may be provided with this information via ANDSF, OMA DM, OTA, SMS, etc.

The user may input the server identification and/or address per application for which the WTRU may contact.

Upon idle mobility into a new area, the WTRU and/or the system may change one or more proximity servers that are currently serving the WTRU. The WTRU may move in idle mode into a new area or a new cell. Upon the transition to connected mode (e.g., due to a NAS Service Request procedure or any other NAS procedures), the MME may use the location of the WTRU to verify a proximity server that suits the WTRU's applications given the WTRU's location. This proximity server may be the proximity server that best suits the WTRU's applications given the WTRU's location. The MME may make use of the current serving cell to verify local MME information and/or to probe another entity, e.g., the HSS to choose the proximity server(s) that best serves the WTRU given its location and application or profile, e.g., subscribed proximity services.

The WTRU may know (e.g., from lower layers) that a new cell and/or a new location may have been entered. The WTRU may have local information that uses location information (e.g., cell ID, tracking area code, CSG ID, etc.) to choose one or more proximity servers that may meet the WTRU's desires given its location and/or its application(s). Such information may be based on a per application basis. For example, different applications may have different choices for a proximity server for the same serving cell and/or location. Some applications may not call for proximity server changes while others may, e.g., due to a change in cell. The WTRU may provide the network, e.g., MME or eNodeB, with the proximity server that may be contacted for the WTRU. This may be done on a per application basis.

The WTRU may provide this information to the MME in NAS messages, e.g., modified NAS messages. The MME may inform the serving eNodeB to establish a connection with this server, for example, as described herein, e.g., via modified S1AP messages. At any point, when the MME has or knows the server that may be contacted by the eNodeB for the WTRU, the MME may provide the server address and/or identification to the eNodeB via, for example, S1AP messages. This may trigger the eNodeB to establish a connection with the server, for example, as described herein. The WTRU may provide this information in RRC messages once it transitions to connected mode.

The system (e.g., MME, eNodeB, and/or WTRU) may change the current proximity server upon handover to a new cell. The current proximity server may be changed with a change in MME and/or SGW. After a WTRU is handed over to a new cell, the MME may change the WTRU's proximity server based on the new location of the WTRU. The MME may use the indications of handover initiation from the source cell or the indication of handover completion (e.g., S1 and/or X2 handovers) from the source or target cell to choose a new proximity server for the WTRU. The MME may use the new location as described herein and choose a different or additional server for the WTRU based on, for example, the WTRU's location and/or applications. The MME may then provide the server address and/or identification to the target eNodeB during or after completion of the handover, e.g., in S1 and/or X2 signaling, which may be a message or modifications to messages. The target eNodeB may establish a connection with one or more proximity servers as indicated by the MME.

Any of the triggers described herein may cause the WTRU to terminate a session with a proximity server and/or may cause the WTRU to establish a session with a new proximity server. The eNodeB may establish a session with a proximity server.

Session termination may imply the termination of a session between a WTRU and a server, and/or between an eNodeB and a server. Session termination may be initiated by a WTRU, a MME, an eNodeB, and/or a server.

A WTRU may send a request to terminate a session with a proximity server. This may be due to a change in the applications that call for communication with the proximity server in question. For example, the WTRU may have local information that maps applications to proximity servers, e.g., identified with a known name or address. According to the WTRU's applications that are running, the WTRU may establish and/or terminate a session with one or more proximity servers using the local information. For example, if a WTRU stops using an application, the WTRU may send a request to terminate a session with the proximity server and may use local information to identify the proximity server as it may be mapped to the application that has been stopped.

The WTRU may send the request to the proximity server itself using proximity messages or a protocol that is running between the WTRU and the proximity server.

Upon receiving a request to terminate a session and/or upon a local trigger to terminate a session with a WTRU (e.g., due to requests from the application provider), the proximity server may inform the MME about the request to terminate the session and/or may inform the MME to terminate any context for the WTRU with this proximity server. The proximity server may request the eNodeB with which it is connected to release any resource or context that has been established for the WTRU on the proposed interface. The proximity server may inform the MME and eNodeB that this may be due to a request from a WTRU and/or due to an application layer request.

The MME, upon receiving a request to terminate a session from the proximity server, may request the eNodeB to terminate a session with the proximity server in question. The MME may save information that indicates that the proximity server in question should not be contacted by eNodeBs until further indication from the WTRU to do so.

The WTRU may send a message to the MME to request the termination of a session with at least one proximity server. The message may be a NAS message (e.g., modified NAS message). The WTRU may include the list of proximity servers (e.g., address or other server identification) in the NAS message and/or a reason for the request to terminate the session. For example, a reason may be set to “deactivation of an application,” “user request,” etc.

Upon receiving a request (e.g., from a WTRU) to terminate a session with a proximity server, the MME may determine or verify whether the request may be granted. For example, a public safety WTRU may not be allowed to initiate a session termination, while the proximity server may be allowed to initiate a session termination with the WTRU. This action may be applied to the proximity server, for example, when the proximity server receives a request to terminate a session for a WTRU (e.g., where the request may have come from the eNodeB, MME, or WTRU).

The MME may forward the request to the proximity server and may wait for the response before it responds to the WTRU.

The MME may command the proximity server to terminate the request and may provide a reason for doing so, e.g., by forwarding the cause code received from the WTRU. The proximity server may take the action or actions described herein.

The MME may indicate to the eNodeB to terminate its connection with the proximity server, for example, as described herein.

The MME may save information locally, e.g., that the WTRU does not want a connection with the proximity server(s) in question and the MME may not request the eNodeBs to establish sessions with the proximity server(s) until a request from the WTRU to do otherwise.

The WTRU may send a message to the eNodeB requesting the termination of a session or connection with one or more server(s) that may be identified such that the eNodeB may contact the appropriate server using this identity. The WTRU may use an RRC message (e.g., a modified RRC message) and may include the one or more servers that may be contacted for session termination. The WTRU may include a cause code to explain the reason for the request.

Upon receiving a request to terminate a session with at least one server (e.g., from the WTRU and/or from the MME, for example, via S1AP messages), the eNodeB may initiate communication with the identified proximity server(s) and may send a message to each proximity server for the purpose of deactivating a session for the WTRU in question.

The implementations described herein for session setup with a proximity server may be used for the purpose of session termination. For example, any protocol or interface that connects an eNodeB and a proximity server may be used to define a message for session termination. The initiating node, which may be the eNodeB or the proximity server, may send a request to terminate a session for a particular WTRU. The initiating node (e.g., the eNodeB) may forward a cause code that may have been received from the WTRU. The eNodeB and the proximity server may release a WTRU context for the interface that connects both nodes.

The proximity server may save local information that indicates that the WTRU may not want any session established. This may be done for one or more applications. The proximity server may stop forwarding information to the WTRU via a node, such as, but not limited to, the MME.

If the WTRU requests to disable proximity services, this may lead to the termination of a connection with a server, for example, as described herein. When the WTRU requests the disabling of proximity services, the WTRU may do so for one or more applications that may be mapped to specific proximity servers. The recipient of this request (e.g., MME or eNodeB) may be able to identify the server address from this mapping. The WTRU may specify the proximity server for which it wishes to disable proximity services. The recipient node of this request (e.g., MME or eNodeB) may contact the proximity server to terminate a session if any exists.

For a WTRU-initiated proximity request (e.g., terminating a session with a proximity server, disabling proximity service for at least one application, etc.), the MME or proximity server, e.g., depending on which node may be processing the request, may verify local rules that may define if the request is allowed or not. For example, a public safety WTRU may not be allowed to terminate a session with a known public safety server, for example, after certain events occur (e.g., an event that may call for public safety services) or during certain time periods. The MME or proximity server may respond and/or reject the WTRU's request and may include a cause code (e.g., “operation not allowed,” “operation not allowed for public safety server,” etc.). The WTRU may refrain from sending such requests for a known time or a signaled time that may be part of the response.

Upon reception of a response (e.g., rejection or acceptance) by the WTRU, the NAS/RRC (or WTRU) may inform higher layers about the response.

A WTRU may be aware of its capability and/or the network's capability to support communication with a proximity server over an interface, e.g., the interface 502 of FIG. 5, which may involve the use of an RRC message. Assuming the WTRU is aware of this capability, the applications and/or proximity service layer in the WTRU may send proximity messages with the proximity server. Since this may be done over RRC messages and may be transparent to the MME (e.g., because the eNodeB may connect to the proximity server), the WTRU may come to RRC connected mode without establishing a NAS signaling connection. The WTRU may be in RRC connected mode and may use RRC messages (e.g., may use only RRC messages) to exchange proximity messages with the proximity server while the MME may be unaware about the WTRU being in connected mode.

The NAS or proximity server layer may have pending requests, e.g., proximity messages, to send to the proximity server and the WTRU may be aware that this does not call for the establishment of a NAS signaling connection with the MME. The NAS or proximity service layer in the WTRU may inform the RRC to establish a connection. The NAS or proximity service layer may indicate to the RRC layer that this is a connection for proximity messaging (or other service or messaging) that does not call for a connection setup with the core network. The NAS may forward an establishment cause to the RRC. The establishment cause may indicate the desire to establish an RRC connection (e.g., only an RRC connection) without establishing a connection with the MME.

The WTRU may establish an RRC connection using an establishment cause to indicate that this is a connection for communication with a proximity server and a connection to the core network (e.g., MME) may not be required.

The WTRU may include an indication in the RRC messages that are sent for a random access procedure. This indication may be in the form of a bit that may inform the eNodeB that the connection is not for the core network.

The WTRU may include an information element or indications in the RRCConnectionSetupComplete to inform the eNodeB that the connection is not intended for the core network. The WTRU may include the proximity server address that should be contacted. The WTRU may include a proximity message that may be piggybacked in the RRCConnectionSetupComplete message or any other message.

The WTRU may come to connected mode, but not to involve the MME (e.g., not for communication with the MME). For example, this may be accomplished by selecting a specific sequence. Reserved sequences (e.g., random access preambles) or a special type of RRC message may be used by the WTRU to indicate such a connection (e.g., RRC connection) with the proximity server and not the MME. For example, a set of random access preambles may be reserved and may be used to indicate that an RRC connection is meant for communicating with the proximity server and not the MME. For example, an indication may be sent in an RRC message header to indicate that the connection is meant for communicating with the proximity server and not the MME.

The eNodeB may use any combination of the indications described herein to know that the connection being setup is not for communication with the core network. For example, the eNodeB may use an RRC establishment cause or an indication in the RRCConnectionSetupComplete message to know that the WTRU may be coming to connected mode for communicating, not with the core network, but rather with another node, such as the proximity server, whose address may be indicated.

Upon reception of these indications, addresses, and/or proximity messages, the eNodeB may establish a connection with the identified proximity server.

The eNodeB may inform the WTRU that a connection has been established with the server. This may be done in an RRC message (e.g., a modified RRC message). For example, the RRCConnectionReconfiguration message may be used and a new IE may be included. The eNodeB may inform the WTRU if the connection establishment with the proximity server was unsuccessful.

The WTRU may inform the eNodeB when communication with the proximity server has terminated. For example, this may be done with an RRC message, e.g., a modified RRC message. The proximity server may inform the eNodeB that communication with the WTRU is terminated. Based on any of these indications, the eNodeB may release the WTRU's RRC connection. The eNodeB may be configured with a timer value that defines an interval of inactivity between the WTRU and the proximity server. When the eNodeB notices inactivity for a specific time interval, then the eNodeB may release the WTRU's connection and inform the proximity server that the WTRU's connection has been released.

If the WTRU desires to send a NAS message to the core network when it is in connected mode for communication (e.g., only for communication), then the WTRU may use the uplink (UL) Information Transfer message. The WTRU may send a modification of this message to include an establishment cause, which may have been sent as part of the RRC connection setup had the WTRU been in idle mode. This may help the eNodeB know the priority and the reason why the WTRU is establishing a connection with the core network. The implementations described herein may apply to UTRAN. For UTRAN, the WTRU may indicate the core network domain in the RRC message. This may enable the eNodeB to forward the NAS message to the appropriate core network domain node (e.g., SGSN or MSC/VLR). The eNodeB may be configured to handle NAS messages with higher priority given that the WTRU may already be in connected mode for communication with a proximity server, e.g., for RRC connection for other services than communication with the core network.

An RRC state and/or a corresponding NAS state may reflect, e.g., may be defined to reflect, a situation in which the WTRU may be in connected mode but without a NAS signaling connection and without a user plane active (e.g., IP traffic). The WTRU may be in connected mode for communication (e.g., via RRC control plane) with a server such as the proximity server that may be connected directly to the RAN or eNodeB. The WTRU may enter this state, for example, when any of the implementations described herein occurs. For example, the WTRU may enter an RRC state when a connection has been established with an establishment cause that reflects no communication with the core network and may reflect communication with a proximity server. The WTRU may enter an RRC state when indications are sent by the WTRU in RRC messages to inform the eNodeB about communication with a server that may be connected to the RAN, and/or with inclusion of a proximity server address or any of the implementations described herein.

An example signaling flow may be used to describe one or more of the implementations described herein. The actions described herein may be performed in any order and are described by way of illustration and not limitation.

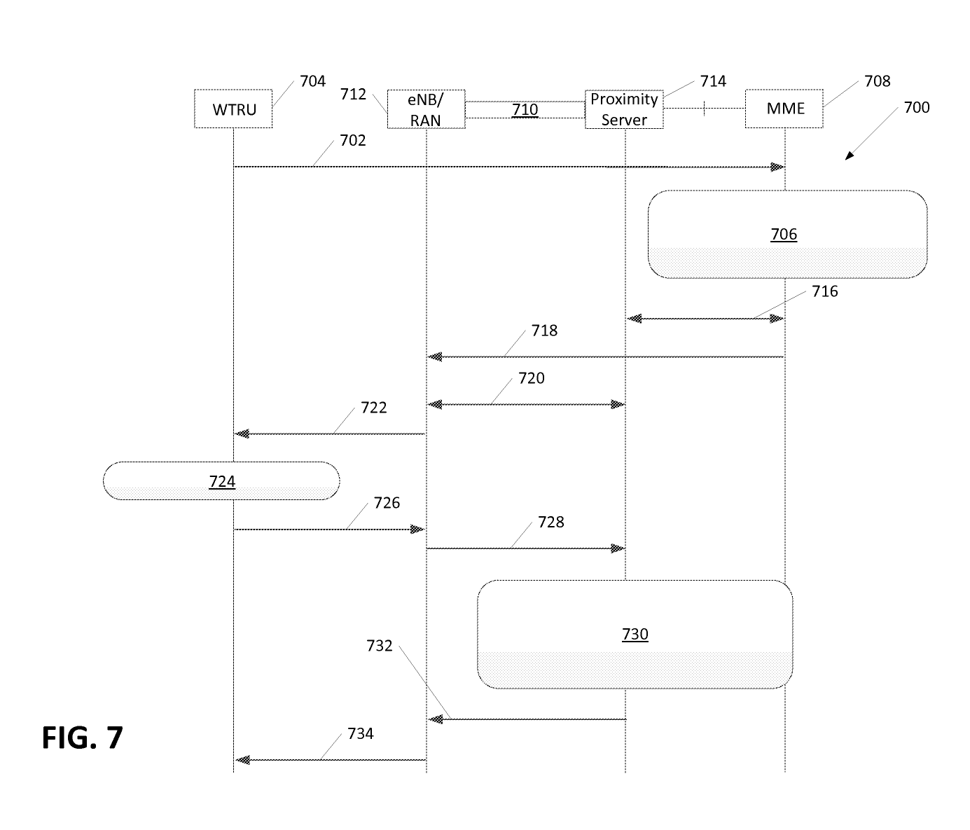

FIG. 7 is a flow diagram illustrating an example signal flow 700. At 702, a WTRU 704 may attach to the system using, for example, an Attach Request message. In the Attach Request message, the WTRU 704 may include its capability indication to send proximity messages over RRC, a list of applications that may call for proximity service and/or a discoverability status per application and/or per peer WTRU (e.g., a list of one or more WTRUs that are to be affected by the current status of the sender WTRU). The WTRU 704 may indicate if it wishes to disable or enable proximity service for at least one application. Disabling or enabling may not be the same as being discoverable or not. For example, a WTRU may enable proximity service and choose to be able to discover other WTRUs but not be discoverable. Disabling proximity service (e.g., on a per application basis) may mean that the WTRU 704 is not interested in receiving any discovery information from the proximity server. If the WTRU 704 has a known proximity service ID, then the WTRU 704 may include this in the NAS message (e.g., this may be applicable to any NAS or RRC message, and may be done on a per application basis).

At 706, an MME 708 may verify the WTRU's subscription, which may or may not indicate that the WTRU 704 is allowed to use proximity services (e.g., send proximity and/or discovery messages) over an interface, e.g., an interface 710 that connects a RAN 712 to a proximity server 714. Based on network policies (e.g., the type of WTRU, the application the WTRU wants to use such as public safety or social network, or the type of applications in the WTRU), subscription, load, location, etc., the MME 708 may perform proximity server selection. For example, based on a capability of a policy, the MME 708 may decide that the WTRU 704 may use an RRC message using the interface 710 to send proximity messages.

At 716, the MME 708 and the proximity server 714 may negotiate a proximity identifier. The MME 708 may provide a cell identifier that serves the WTRU 704. The MME 708 may contact the selected proximity server 714 to indicate the WTRU's availability in the system. The MME 708 may include the information received from the WTRU 704, e.g., number of proximity applications, WTRU's preference for proximity status, which may be done on a per application basis, and/or one or more affected peer WTRUs as per the requesting WTRU's desire for discoverability/discovery. The MME 708 may forward an indication about the type of application(s) that may be permitted as per subscription information. The MME 708 may provide an identifier for the WTRU to be used in the proximity server 714. This identifier may be a known WTRU-provided identifier, the S-TMSI as assigned by the MME 708, or other unique identifier. This identifier may be used by the MME 708 and the proximity server 714 for further communication regarding this WTRU 704. The identifier may be reassigned by the MME 708 when the WTRU 704 goes to connected mode the next time, based on location, or other network policies. The same steps or procedures in the signal flow 700 may occur if a WTRU is handed over from another system or when the WTRU performs inter-RAT idle mode reselection to E-UTRAN. The MME 708 may provide the cell identifier that is currently serving the WTRU 704. The proximity server 714 may store such location information for the WTRU in question.

At 718, the MME 708 may perform an initial context setup (e.g., an Attach Accept). This may include an indication to use an interface, e.g., a direct interface, a proximity identifier, a server address, etc. The MME 708 may send an S1AP message to the eNodeB or RAN 712 (e.g., the Initial Context Setup Request) and may include an indication that the eNodeB or RAN 712 may configure the WTRU 704 to use RRC messages to send proximity requests, at least one proximity server address to use for this WTRU, a proximity identifier or any other identifier that the eNodeB or RAN 712 may use when it communicates with the proximity server 714 (e.g., S-TMSI or any other MME/server allocated identifier that may be available at the MME 708). The message may piggyback the NAS Attach Accept message.

At 720, the eNodeB or RAN 712 may establish a session with the proximity server 714 for the WTRU 704 using the signaled proximity identifier. The eNodeB or RAN 712 and the proximity server 714 may establish another unique identifier to distinguish WTRU sessions. The eNodeB or RAN 712 may perform C-RNTI-to-proximity identifier mapping. The eNodeB or RAN 712 may establish a connection with at least one server, e.g., based on the indication received from the MME, an indication that indicates the WTRU can use RRC messages for proximity service, based on an availability of at least one proximity server address, and/or one or more of the implementations described herein. The eNodeB or RAN 712 may provide a proximity/session identifier that may have been received at 718 or that may have been generated by the eNodeB or RAN 712. The eNodeB or RAN 712 may provide the identity of the cell (e.g., global cell ID, CSG ID, local network identifier, etc.). The eNodeB or RAN 712 may maintain a mapping between the WTRU's C-RNTI and the proximity/session identifier used for the WTRU 704, e.g., assigned by the eNodeB or RAN 712, the MME 708, or the proximity server 714. The eNodeB or RAN 712 may use the proposed interface, e.g., which may be IP-based, to establish a session with the server for the WTRU 704. This may be performed by the proximity server 714. For example, the proximity server 714 may establish the connection with the eNodeB or RAN 712 after 716 and the MME 708 may have provided or may provide an eNodeB address that the proximity server 714 may use to contact the eNodeB or RAN 712 (or cell global ID, CSG ID, etc.) and the proximity server 714 may use this to get the eNodeB address that may be used for communication.

At 722, the eNodeB or RAN 712 may send an RRC message to the WTRU 704, e.g., the RRC Connection Reconfiguration message, which may include a NAS message such as the Attach Accept message. The eNodeB or RAN 712 may indicate in the message that the WTRU 704 may use RRC messages to send proximity requests. The eNodeB or RAN 712 may indicate that the eNodeB or RAN 712 may connect to a proximity server. This may trigger the WTRU 704 to start sending proximity messages over RRC signaling. The eNodeB or RAN 712 may provide a proximity server name that may have been provided by the MME 708 or the proximity server 714. The WTRU 704 may include a proximity server name when it attaches to the system or in any of its NAS/RRC messages. The proximity server name may be used by the network to fetch previous proximity service context from a previous proximity server. The network may send the Attach Accept message to the WTRU 704, which may include any of the indications as described herein. The WTRU 704 may provide proximity information/indication to upper layers, e.g., a proximity server name.

At 724, based on a trigger (e.g., as defined herein), the WTRU 704 may decide to send a message, e.g., a discovery request to the proximity server 714, e.g., due to user modification of the proximity status update via the user interface. This may be done for one or more applications and/or for one or more WTRUs per application. At 726, the WTRU 704 may send a proximity message in an RRC message (e.g., modified RRC message) to the eNodeB or RAN 712. The proximity message may be in a NAS message. The WTRU 704 may include its proximity service identifier and/or a proximity server name and/or address.

The RRC message, e.g., a modified RRC message, may be received by the eNodeB or RAN 712, which may know that the message should be sent directly to the proximity server 714 at 728 instead of the MME 708, e.g., based on the use of a message, a modified message, or based on the contents of the message such as, but not limited to the inclusion of a proximity server name. The message may be sent to the proximity server 714, for example, using the interface 710. The eNodeB or RAN 712 may include an identifier based on C-RNTI-to-proximity identifier mapping or another form of mapping. The eNodeB or RAN 712 may use a proximity service ID and/or a proximity server name/address that may be provided by the WTRU 704 in order to send the message to the appropriate server. The eNodeB or RAN 712 may use some local mapping information to contact the appropriate server. The eNodeB or RAN 712 may forward the received message to the proximity server 714. The message may be sent over the interface 710. The eNodeB or RAN 712 may include an identity to distinguish the WTRU 704 at the proximity server 714. This may be an identity provided by the WTRU 704, may be an identity that was negotiated between the eNodeB or RAN 712 and the proximity server 714, or may have been provided by the MME 708.

At 730, the proximity server 714 may verify the session identifier (or proximity identifier, or any other identifier that may uniquely distinguish the WTRU in question) that is received from the eNodeB or RAN 712. The proximity server 714 may or may not accept the request. If the identifier does not match any of the proximity server's session (or proximity) identities that may be in use for a WTRU, then the proximity server 714 may send a rejection message to the eNodeB or RAN 712 (and/or to the WTRU 704, MME 708, etc.) to indicate that no context or entry was found for this WTRU 704. The proximity server 714 may verify the WTRU's request and may then update the WTRU's proximity status accordingly. The proximity server 714 may communicate such updates to the MME. The proximity server 714 may verify the applications that are affected and/or the WTRUs that may be notified or affected by the request. The proximity server 714 may contact these WTRUs to update them based on the request, e.g., to make the sender WTRU become discoverable or undiscoverable, for example, for at least one application. The proximity server may know about the WTRU's locations (e.g., on a cell level) and may therefore contact these WTRUs, e.g., via the MME 708 or via the eNodeB or RAN 712 as per the implementations described herein. The proximity server 714 may set triggers at the MME 708. Although not shown in FIG. 7, the proximity server 714 may communicate to the MME 708 and request it to inform the proximity server 714 when certain identified WTRUs go to connected mode. If the proximity server 714 uses a proximity service identifier that is unique in the system, the proximity server 714 may request the eNodeBs to monitor and update it when the identified WTRUs (e.g., those identified with the proximity service identifier) come to connected mode as these WTRUs may provide a proximity service identifier in the RRC messages, e.g., upon transition to connected mode. The eNodeB or RAN 712 may use the provided WTRU proximity ID and that provided by the proximity server 714 to compare for a match. If a match is detected, then the eNodeB or RAN 712 may send a notification to inform the proximity server 714 that the WTRU 704 has been detected and may provide the proximity service ID. This may be done even if the WTRU 704 may be coming to connected mode for signaling (e.g., only signaling), such as for a periodic tracking area update. This event-based notification may be done by the MME 708, for example, based on the received request, which may have other WTRUs updated.

At 732, based on a trigger, e.g., as described herein, the proximity server 714 may send a message to the WTRU 704, e.g., because it may know that the WTRU 704 is in connected node and in a particular cell/eNodeB. The message may be a response to a previous request or it may be any other proximity service request. The proximity server 714 may forward the message to the eNodeB or RAN 712 for transmission to the WTRU. The proximity server 714 may use the interface 710 to send the message to the WTRU 704, e.g., via the eNodeB or RAN 712. The proximity server 714 may include an identity that may allow the eNodeB or RAN 712 to distinguish the WTRU for which this message is intended. The eNodeB or RAN 712 may perform a mapping to know the C-RNTI that may be allocated for the WTRU under consideration, and may send the message to the appropriate WTRU.

At 734, the eNodeB or RAN 712 may forward the proximity message to the WTRU 704 via an RRC message, e.g., a modified RRC message. The eNodeB or RAN 712 may use the identifier included at 732 to send the proximity message to the appropriate WTRU. The WTRU 704 may receive the proximity message and forward it to upper layers.

The processes and instrumentalities described herein may apply in any combination, may apply to other wireless technology, and for other services (e.g., not limited for proximity services).

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed:

1. A method of establishing a connection between an eNodeB and a proximity server, the method comprising:
receiving, with an eNodeB, an indication to establish an interface between the eNodeB and a proximity server;
establishing a direct interface between the eNodeB and the proximity server, the direct interface comprising a control plane interface;
transmitting data between the proximity server and a wireless transmit/receive unit (WTRU) using the interface; and
receiving the data at the WTRU using the interface.

2. The method of claim 1, wherein the only logical node between the WTRU and the proximity server on the direct interface is the eNodeB.

3. The method of claim 1, wherein the direct interface excludes a mobility management entity (MME).

4. The method of claim 1, wherein the indication comprises a S1AP message received from a mobility management entity (MME).

5. The method of claim 1, wherein the indication comprises an RRC message received from the WTRU.

6. The method of claim 5, wherein the RRC message encapsulates a NAS message.

7. The method of claim 1, wherein the indication comprises discovery of the proximity server by the eNodeB.

8. The method of claim 1, further comprising indicating to the WTRU to use the interface to receive the data via at least one of an Access Network Discovery and Selection Function (ANDSF) indication, an Open Mobile Alliance Device Management (OMA DM) indication, an Over the Air (OTA) indication, or an Short Messaging Service (SMS) indication.

9. The method of claim 1, further comprising:
transmitting a request to establish for a proximity service from the WTRU to the proximity server using the interface; and
establishing, with the proximity server, a proximity service for at least one of an application or a user within an application with the WTRU using the interface.

10. The method of claim 9, further comprising exchanging capability information between the proximity server and the WTRU to indicate support for messaging using the interface.

11. The method of claim 1, wherein at least one of the eNodeB or the proximity server uses a unique session identifier to identify the WTRU.

12. The method of claim 1, further comprising, prior to establishing the interface between the eNodeB and the proximity server:
transmitting, with the WTRU, at least one of an address or a name of the proximity server to the mobility management entity (MME);
receiving, with the MME, the at least one of the address or the name of the proximity server; and
transmitting, with the MME, an indication to the eNodeB to set up the interface between the eNodeB and the proximity server for the WTRU.

13. The method of claim 1, wherein the WTRU stores subscription information that indicates whether the WTRU can communicate with the proximity server using the interface.

14. The method of claim 1, further comprising:
configuring the WTRU to send a proximity message during a defined time period; and
configuring a maximum number of allowed proximity message transmissions during the defined time period.

15. The method of claim 1, further comprising configuring an event at one or more of a mobility management entity (MME) and the eNodeB for the proximity server to receive a notification about the WTRU entering a connected mode.

16. The method of claim 15, wherein the notification comprises a location of the WTRU.

17. The method of claim 1, further comprising processing, by the proximity server, a proximity request received in a NAS message.

18. The method of claim 1, further comprising sending a discovery message from the proximity server to the WTRU using the interface to update the WTRU.

19. The method of claim 1, wherein the WTRU is configured to enter a connected mode to communicate with the proximity server without using a NAS message.

20. A proximity server comprising a processor and a memory, the memory storing instructions that, when executed by the processor, cause the proximity server to:
establish a direct control plane interface between the proximity server and an eNodeB; and
transmit data between the proximity server and a wireless transmit/receive unit (WTRU) using the interface.

21. The proximity server of claim 20, wherein direct control plane interface, such that consists of the eNodeB.

22. The proximity server of claim 20, wherein the direct control plane interface excludes a mobility management entity (MME).

23. The proximity server of claim 20, wherein the indication comprises at least one of a S1AP message received from a mobility management entity (MME), and an RRC message received from the WTRU encapsulating a NAS message.

24. The proximity server of claim 20, wherein the proximity server is configured to indicate to the WTRU to use the interface to receive the data via at least one of an Access Network Discovery and Selection Function (ANDSF) indication, an Open Mobile Alliance Device Management (OMA DM) indication, an Over the Air (OTA) indication, an Short Messaging Service (SMS) indication, or discovery of the proximity server by the eNodeB.

25. The proximity server of claim 20, wherein the proximity server is further configured to:
receive a request to establish for a proximity service from the WTRU to the proximity server using the interface; and
establish a proximity service for at least one of an application or a user within an application with the WTRU using the interface.

26. The proximity server of claim 25, wherein the proximity server is further configured to exchange capability information with the WTRU to indicate support for messaging using the interface.

27. The proximity server of claim 20, wherein the proximity server uses a unique session identifier to identify the WTRU.

28. The proximity server of claim 20, wherein the proximity server is further configured to configure an event at one or more of a mobility management entity (MME) and the eNodeB for the proximity server to receive a notification about the WTRU entering a connected mode.

29. The proximity server of claim 20, wherein the proximity server is further configured to process a proximity request received in a NAS message.

30. The proximity server of claim 20, wherein the proximity server is further configured to send a discovery message from the proximity server to the WTRU using the interface to update the WTRU.
